(19) United States
(12) Patent Application Publication
(10) Pub. No.: US 2025/0118070 A1
(43) Pub. Date: Apr. 10, 2025

(54) METHOD FOR PROVIDING CUSTOMIZED TOUR GUIDE CONTENT AND TERMINAL FOR IMPLEMENTING SAME

(71) Applicant: LG ELECTRONICS INC., Seoul (KR)

(72) Inventors: Jihyun SONG, Seoul (KR); Hyongguk KIM, Seoul (KR); Mojeong KIM, Seoul (KR)

(73) Assignee: LG ELECTRONICS INC., Seoul (KR)

(21) Appl. No.: 18/730,965

(22) PCT Filed: Feb. 14, 2022
(86) PCT No.: PCT/KR2022/002164

§ 371 Date: Jul. 22, 2024

(51) Int. Cl. G06V 20/20; G06F 3/04842; G06F 3/16; G06Q 50/14

(52) U.S. Cl. CPC G06V 20/20; G06F 3/167; G06Q 50/14; G06F 3/04842

(57) ABSTRACT

The objective of the present invention is to provide a method for providing customized tour guide content that can provide appropriate tour content to a user with minimal input from the user by using at least one of user data during a tour, movement data, and tour destination data, and a terminal for implementing same. One aspect of the present invention may provide a user terminal comprising: a display; a microphone; a location information module; a camera; and a control unit that displays on said display a real-time video sensed through the camera on the display; analyzes in real time a plurality of objects included in the real-time video through an analysis of the real-time video; analyzes, by means of artificial intelligence, at least one of the current location and direction sensed through the location information module and a user's voice inputted through the microphone to select an object that matches the user's voice; when the selected object is included in the real-time video that is currently displayed on the display, displays the real-time video and selected object information of the selected object together while highlighting the selected object in the real-time video; and, when the selected object is not included in the real-time video that is currently displayed on the display, displays the real-time video and the selected object information together without highlighting the object in the real-time video.

### TECHNICAL FIELD

The present disclosure relates to a method of providing user-customized tour guide content and a terminal for implementing the same.

### BACKGROUND ART

User terminals may be generally classified as mobile/portable terminals or stationary terminals according to their mobility. User terminals may also be classified as handheld terminals or vehicle mounted terminals according to whether or not a user can directly carry the terminal.

User terminals have become increasingly more functional. Examples of such functions include data and voice communications, capturing images and video via a camera, recording audio, playing music files via a speaker system, and displaying images and video on a display. Some user terminals include additional functionality which supports game playing, while other terminals are configured as multimedia players. More recently, user terminals have been configured to receive broadcast and multicast signals which permit viewing of content such as videos and television programs.

User terminals may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players.

Recently, many people have become more interested in traveling and tend to obtain various travel information through user terminals while traveling. In many cases, a user accesses a specific website or executes a specific application through a user terminal and obtains desired travel information (i.e., travel content) through results searched by entering search keywords into the accessed website or the executed applications (i.e., through search results.

In order to search for a desired result, an accurate search keyword should be entered, but it is often difficult for the user to come up with accurate search keywords. This is especially true when the user is traveling to a destination for the first time.

### DISCLOSURE

### Technical Problem

The present disclosure provides a method of providing user-customized tour guide content capable of providing appropriate travel content to a user only with minimal user intervention using at least one of user data, movement data, and travel destination data while traveling, and a terminal for implementing the same.

### Technical Solution

According to an aspect of the present disclosure, provided herein is a user terminal including a display unit, a microphone, a location information module, a camera, and a controller. The controller is configured to display a real-time image sensed through the camera on the display unit, analyze, in real time, a plurality of objects included within the real-time image through analysis of the real-time image and select an object corresponding to voice of a user by analyzing, through artificial intelligence, at least one of a current location and a direction sensed through the location information module and the voice of the user input through the microphone, display the real-time image and selected object information of the selected object together while highlighting the selected object within the real-time image, based on the selected object being included within the real-time image currently displayed on the display unit, and display the real-time image and the selected object information together without highlighting the selected object, based on the selected object being not included within the real-time image currently displayed on the display unit.

Based on the selected object being included within the real-time image currently displayed, the controller may perform a control operation to vary a location at which the selected object information is displayed on the display unit depending on a location of the selected object within the real-time image.

Based on the selected object being not included within the real-time image currently displayed, the controller may perform a control operation to display the selected object information at a preset location of the display unit.

The user terminal may further include a memory, and the controller may perform a control operation to identify at least one object among the plurality of objects within the real-time image, tag the identified object with identification information, and store, in the memory, the real-time image including the identification information with which the at least one object is tagged.

Based on the selected object being not within the real-time image currently displayed, the controller may perform a control operation to search for a duration in which the identification information related to the selected object is tagged in the stored real-time image and play a clip of the real-time image of the searched duration together with the selected object information.

Based on the selected object being included within the real-time image currently displayed, the controller may perform a control operation not to play the clip of the real-time image of the searched duration upon displaying the selected object information.

The user terminal may further include a wireless communication unit, and the controller may perform a control operation to transmit identification information of the selected object to an external platform through the wireless communication unit, receive at least one of text, sound, or image information related to the identification information through the wireless communication unit from the external platform, and include the at least one of the text, the sound, or the image information in the selected object information.

The controller may perform a control operation to display selected object information of different types according to a movement speed of the user.

The controller may perform a control operation to display the selected object information of a detailed version based on the movement speed being equal to or greater than a certain speed, and display the selected object information of a simplified version based on the movement speed being less than the certain speed.

Based on the selected object information of the simplified version being selected by the user, the controller may perform a control operation to display the selected object information of the detailed version.

Based on the voice of the user being sensed while an execution screen of another application being executed in a foreground is displayed on the display unit, the controller may perform a control operation to simultaneously display a screen of the selected object information and the execution screen of the other application by splitting a screen of the display unit.

Based on selection of the screen of the selected object information by the user, the controller may perform a control operation to display the real-time image and the selected object information in full screen.

The user terminal may further include a voice output unit, and based on a power saving mode of the display unit at a time point at which the voice of the user is sensed, the controller may perform a control operation to output the selected object information only with audio through the voice output unit.

Based on the display unit switching to a non-power saving mode, the controller may perform a control operation to display the real-time image and the selected object information in full screen.

The controller may perform a control operation to output audio of different types according to a movement speed of the user.

The controller may perform a control operation to output audio of the selected object information of a simplified version based on the movement speed being equal to or greater than a certain speed, and output audio of the selected object information of a detailed version based on the movement speed being less than the certain speed.

The controller may perform a control operation to display the selected object information, based on the selected object being included within the real-time object and the selected object being located within a predetermined distance.

The controller may perform a control operation to display a plurality of object information for the plurality of objects together with a plurality of object type icons.

Based on selection of at least one of the plurality of object type icons by the user, the controller may perform a control operation to display only information of at least one object related to the selected at least one object type icon among the plurality of objects.

According to another aspect of the present disclosure, provided herein is a method of controlling a user terminal, including displaying a real-time image sensed through a camera on a display unit, analyzing, in real time, a plurality of objects included within the real-time image through analysis of the real-time image and selecting an object corresponding to voice of a user by analyzing, through artificial intelligence, at least one of a current location and a direction sensed through a location information module and the voice of the user input through a microphone, and displaying the real-time image and selected object information of the selected object together while highlighting the selected object within the real-time image, based on the selected object being included within the real-time image currently displayed on the display unit.

### Advantageous Effects

A method of providing user-customized tour guide content and a terminal for implementing the same according to the present disclosure have the following effects.

According to at least one of the various aspects of the present disclosure, appropriate tour guide content is capable of being provided to a user only with minimal user intervention using at least one of user data, movement data, and travel destination data while traveling.

### BRIEF DESCRIPTION OF DRAWINGS

FIG. 1 is a schematic block diagram of a user terminal according to the present disclosure.

FIG. 2 illustrates interworking between a user terminal and an external device according to an aspect of the present disclosure.

FIG. 3 illustrates a vehicle interworking with a user terminal according to an aspect of the present disclosure.

FIG. 4 illustrates an example of collection of movement data for providing user-customized tour guide content according to an aspect of the present disclosure.

FIG. 5 illustrates an example of collection of user data for providing user-customized tour guide content according to an aspect of the present disclosure.

FIG. 6 illustrates an example of collection of tour point data for providing user-customized tour guide content according to an aspect of the present disclosure.

FIG. 7 is a flowchart of a process for providing user-customized tour guide content according to an aspect of the present disclosure.

FIG. 8 is a flowchart of a process for providing user-customized tour guide content according to one aspect of the present disclosure.

FIG. 9 is a flowchart of a process for providing user-customized tour guide content in situation 1 of FIG. 8.

FIG. 10 is a flowchart of a process for providing user-customized tour guide content in situation 2 of FIG. 8.

FIG. 11 is a flowchart of a process for providing user-customized tour guide content in situation 3 of FIG. 8.

FIG. 12 is a flowchart of a process for providing user-customized tour guide content in situation 4 of FIG. 8.

FIG. 13 illustrates a display screen providing the tour guide content in situation 1 of FIG. 9.

FIG. 14 illustrates a display screen providing the tour guide content in situation 2 of FIG. 10.

FIG. 15 illustrates an example of the tour guide content provided in situation 3 of FIG. 11.

FIG. 16 illustrates an example of the tour guide content provided in situation 4 of FIG. 12.

FIG. 17 illustrates a screen in which the tour guide content provided according to FIG. 7 is displayed.

FIG. 18 illustrates an example of a distance range in which tour guide content is displayed according to an aspect of the present disclosure.

FIG. 19 illustrates an example of selecting a type of tour guide content according to an aspect of the present disclosure.

FIG. 20 illustrates an example of selecting a real-time image to be displayed according to an aspect of the present disclosure.

FIG. 21 illustrates an example of sharing tour guide content according to an aspect of the present disclosure.

FIG. 22 is a flowchart of a process for providing user-customized tour guide content according to an aspect of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

In this disclosure, the expression “at least one of A or B” may mean “A”, “B”, or “A and B”.

User terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of user terminals. However, such teachings apply equally to other types of terminals, such as those types noted above. In addition, these teachings may also be applied to stationary terminals such as digital TV, desktop computers, and the like.

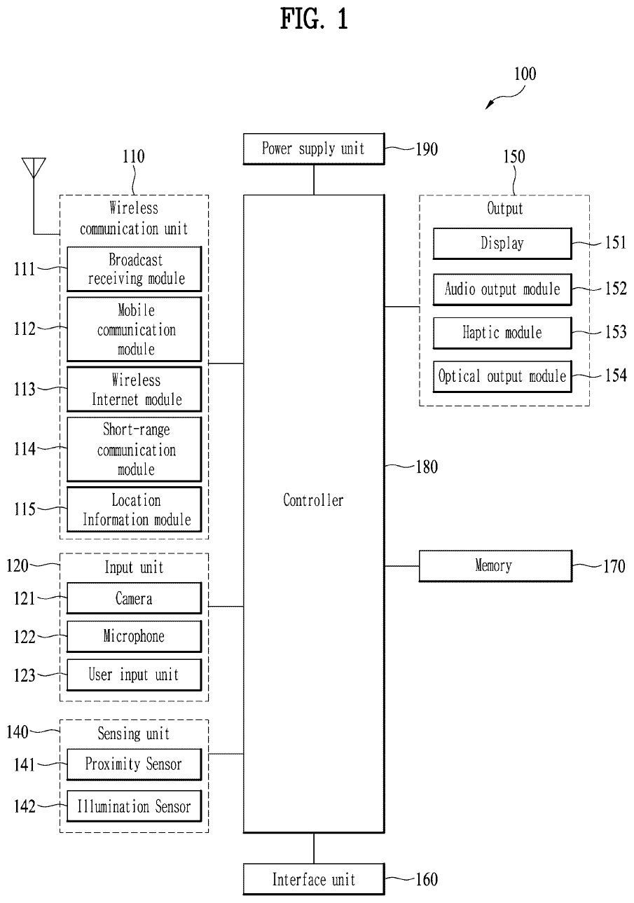

Reference is now made to FIG. 1, which is a block diagram of a user terminal in accordance with the present disclosure.

The user terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

More specifically, the user terminal 100 is shown having wireless communication unit 110 configured with several commonly implemented components. For instance, the wireless communication unit 110 typically includes one or more components which permit wireless communication between the user terminal 100 and a wireless communication system or network within which the user terminal is located.

The wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the user terminal, the surrounding environment of the user terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The user terminal disclosed in the present specification may utilize a combination of information sensed by at least two of these sensors.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the user terminal 100 and a user, as well as function as the user input unit 123 which provides an input interface between the user terminal 100 and the user.

The interface unit 160 serves as an interface with various types of external devices that can be coupled to the user terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the user terminal 100 may perform assorted control functions associated with a connected external device, in response to the external device being connected to the interface unit 160.

The memory 170 is typically implemented to store data to support various functions or features of the user terminal 100. For instance, the memory 170 may be configured to store application programs executed in the user terminal 100, data or instructions for operations of the user terminal 100, and the like. Some of these application programs may be downloaded from an external server via wireless communication. Other application programs may be installed within the user terminal 100 at time of manufacturing or shipping, which is typically the case for basic functions of the user terminal 100 (for example, receiving a call, placing a call, receiving a message, sending a message, and the like). It is common for application programs to be stored in the memory 170, installed in the user terminal 100, and executed by the controller 180 to perform an operation (or function) for the user terminal 100.

The controller 180 typically functions to control overall operation of the user terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170.

The controller 180 controls some or all of the components illustrated in FIG. 1 according to the execution of an application program that have been stored in the memory 170. Furthermore, the controller 180 may operate at least two of the components included in the user terminal 100 in combination with each other in order to execute the application program.

The power supply unit 190 receives internal power or external power and supplies power to components included in the user terminal 100, under control of the controller 180. The power supply unit 190 may include a battery, and the battery may be configured to be embedded in the terminal body, or configured to be detachable from the terminal body.

At least some of the components may operate in cooperation with each other to implement an operation, control, or a control method of the user terminal according to various embodiments to be described below. In addition, the operation, the control, or the control method of the user terminal may be implemented on the user terminal by driving at least one application program stored in the memory 170.

Hereinbelow, prior to a description of various embodiments implemented through the user terminal 100 discussed above, the components listed above will be described in more detail with reference to FIG. 1.

Regarding the wireless communication unit 110, the broadcast receiving module III is typically configured to receive a broadcast signal and/or broadcast associated information from an external broadcast managing entity via a broadcast channel. The broadcast channel may include a satellite channel, a terrestrial channel, or both. Two or more broadcast receiving modules may be provided to the mobile terminal 100 to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the user terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external user terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), 5G, and the like).

Examples of wireless signals include audio call signals, video (telephony) call signals, or various formats of data to support communication of text and multimedia messages.

The wireless Internet module 113 is configured to facilitate wireless Internet access. This module may be internally or externally coupled to the user terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), 5G and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A, 5G and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include Bluetooth™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the user terminal 100) and a wireless communication system, communications between the user terminal 100 and another user terminal 100, or communications between the user terminal and a network where another user terminal 100 (or an external server) is located, via wireless area networks. One example of the wireless area networks is a wireless personal area networks.

In some embodiments, another user terminal (which may be configured similarly to user terminal 100) may be a wearable device, for example, a smart watch, a smart glass or a head mounted display (HMD), which is able to exchange data with the user terminal 100 (or otherwise cooperate with the user terminal 100). The short-range communication module 114 may sense or recognize the wearable device, and permit communication between the wearable device and the user terminal 100. In addition, when the sensed wearable device is a device which is authenticated to communicate with the user terminal 100, the controller 180, for example, may cause transmission of data processed in the user terminal 100 to the wearable device via the short-range communication module 114. Hence, a user of the wearable device may use the data processed in the user terminal 100 on the wearable device. For example, when a call is received in the user terminal 100, the user may answer the call using the wearable device. Also, when a message is received in the user terminal 100, the user can check the received message using the wearable device.

The location information module 115 is generally configured to detect, calculate, derive or otherwise identify a position of the user terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the user terminal. As one example, when the user terminal uses a GPS module, a position of the user terminal may be acquired using a signal sent from a GPS satellite. As another example, when the user terminal uses the Wi-Fi module, a position of the user terminal can be acquired based on information related to a wireless access point (AP) which transmits or receives a wireless signal to or from the Wi-Fi module.

The input unit 120 may be configured to permit various types of input to the user terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the user terminal 100. As another example, the cameras 121 may be located in a stereoscopic arrangement to acquire left and right images for implementing a stereoscopic image. The plurality of cameras 121 may include a depth camera and/or a time of flight (TOF) camera for three-dimensionally sensing a subject.

The microphone 122 is generally implemented to permit audio input to the user terminal 100. The audio input can be processed in various manners according to a function being executed in the user terminal 100. If desired, the microphone 122 may include assorted noise removing algorithms to remove unwanted noise generated in the course of receiving the external audio.

The user input unit 123 is a component that permits input by a user. Such user input may enable the controller 180) to control operation of the user terminal 100. The user input unit 123 may include one or more of a mechanical input element (for example, a key, a button located on a front and/or rear surface or a side surface of the user terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the user terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the user terminal, surrounding environment information of the user terminal, user information, or the like. The controller 180 generally cooperates with the sending unit 140 to control operation of the user terminal 100 or execute data processing, a function or an operation associated with an application program installed in the user terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the user terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the user terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the user terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the user terminal 100. For example, the display unit 151 may display execution screen information of an application program executing at the user terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the user terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the user terminal 100.

An optical output module 154 can output a signal for indicating an event generation using light of a light source. Examples of events generated in the user terminal 100 may include message reception, call signal reception, a missed call, an alarm, a schedule notice, an email reception, information reception through an application, and the like.

A signal output by the optical output module 154 may be implemented in such a manner that the user terminal emits monochromatic light or light with a plurality of colors. The signal output may be terminated as the user terminal senses that a user has checked the generated event, for example.

The interface unit 160 serves as an interface for external devices to be connected with the user terminal 100. For example, the interface unit 160 can receive data transmitted from an external device, receive power to transfer to elements and components within the user terminal 100, or transmit internal data of the user terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the user terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the user terminal 100 is connected with an external cradle, the interface unit 160 can serve as a passage to allow power from the cradle to be supplied to the user terminal 100 or may serve as a passage to allow various command signals input by the user from the cradle to be transferred to the user terminal there through. Various command signals or power input from the cradle may operate as signals for recognizing that the user terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The user terminal 100 may also be operated in relation to a network storage device that performs the storage function of the memory 170 over a network, such as the Internet.

The controller 180 may typically control the general operations of the user terminal 100. For example, the controller 180 may set or release a lock state for restricting a user from inputting a control command with respect to applications when a status of the user terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the user terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

A function related to artificial intelligence according to the present disclosure may be performed through a controller and a memory. The controller may include one or more processors. In this case, one or more processors may be a general-purpose processor such as a CPU, an AP, or a digital signal processor (DSP), a graphics-only processor such as a GPU and a vision processing unit (VPU), or an artificial intelligence-only processor such as an NPU. One or more processors may perform control to process input data according to a predefined operation rule or artificial intelligence model stored in the memory. Alternatively, when one or more processors are AI-only processors, the AI-only processor may be designed with a hardware structure specialized for processing a specific AI model.

The predefined operation rule or the artificial intelligence model may be created through learning. Here, creation through learning means that a predefined operation rule or an artificial intelligence model configured to perform a desired characteristic (or purpose) is created by learning a basic artificial intelligence model using a large number of learning data by a learning algorithm. Such learning may be performed in a device itself on which artificial intelligence according to the present disclosure is performed, or may be performed through a separate server and/or system. Examples of the learning algorithm include, but are not limited to, supervised learning, unsupervised learning, semi-supervised learning, or reinforcement learning.

The artificial intelligence model may include a plurality of neural network layers. Each of the plurality of neural network layers may have a multiple weight values and may perform neural network computation through a computation result of a previous layer and computation between the multiple weight values. The multiple values of the plurality of neural network layers may be optimized according to the learning result of the artificial intelligence model. For example, the multiple weight values may be updated to reduce or minimize a loss value or a cost value obtained from the artificial intelligence model during a learning process. An artificial neural network may include a deep neural network (DNN), and for example, may be a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network), but is not limited to the above-described example.

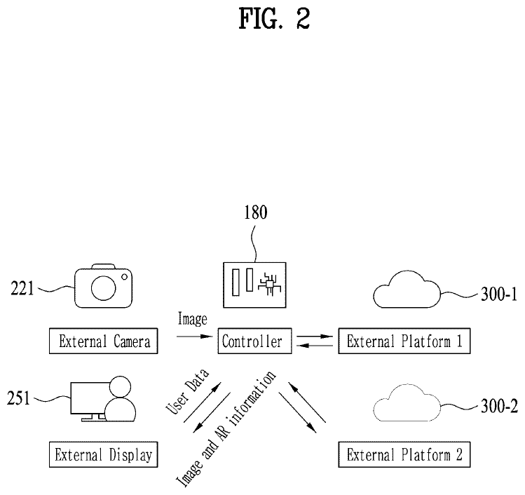

The user terminal 100 may operate by interworking with an external device and/or an external platform. This will be described further with reference to FIG. 2. FIG. 2 illustrates interworking between a user terminal and an external device according to an aspect of the present disclosure.

The controller 180 of the user terminal 100 may operate by interworking with at least one external device. The user terminal 100) may be connected to the at least one external device by wire through the interface unit 160 or may be connected to the at least one external device wirelessly through the wireless communication unit 110.

For example, the controller 180 may receive an image sensed in real time by at least one external camera 221.

The controller 180 may transmit an image, augmented reality (AR) information, and/or extended reality (XR) information to at least one external display unit 251 so as to be displayed. In addition, when the external display unit 251 is configured as a touchscreen, the controller 180 may receive a signal regarding a touch gesture input from a user through the external display unit 251.

The controller 180 of the user terminal 100 may operate by interworking with at least one external platform (or server) 300-1 or 300-2. The user terminal 100 may be wirelessly connected to the at least one external platform 300-1 or 300-2 through the wireless communication unit 110. Data exchanged between the user terminal 100 and the at least one external platform 300-1 or 300-2 will be described later.

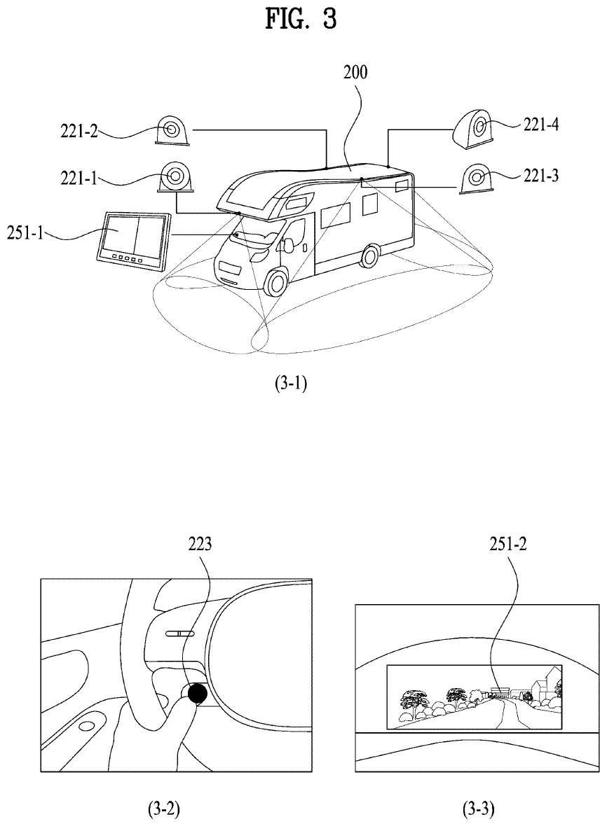

In particular, the user terminal 100 may operate by interworking with a vehicle 200 or a device mounted in the vehicle 200. This will be described further with reference to FIG. 3. FIG. 3 illustrates a vehicle interworking with a user terminal according to an aspect of the present disclosure.

As illustrated in (3-1) of FIG. 3, the controller 180 of the user terminal 100 may operate by interworking with at least one camera 221-1, 221-2, 221-3, or 221-4 mounted in the vehicle 200. In FIG. 3, the at least one camera is illustrated as including the front camera 221-1, the right camera 221-2, the left camera 221-3, or the rear camera 221-4.

As illustrated in (3-1) of FIG. 3, the controller 180 may operate by interworking with a first display unit 251-1 provided in the vehicle. The first display unit 251-1 may display, for example, a navigation guidance screen and may also display an image sensed by the at least one camera when a specific event (e.g., a user command, etc.) occurs.

As illustrated in (3-2) of FIG. 3, the controller 180 may operate by interworking with a user input unit 223 (e.g., a button, a dome switch, a jog wheel, a jog switch, a touch type input means, etc.) provided on a steering wheel of the vehicle. For example, when a user command is input through the user input unit 223, the controller 180 may display an image sensed by the at least one camera on the first display unit 251-1 and/or a second display unit 251-2 provided in the vehicle. In (3-3) of FIG. 3, the image sensed by the at least one camera is illustrated as being displayed on the second display unit 251-2 provided as a digital dashboard display unit of the vehicle.

When the image sensed by the at least one camera is displayed on the first display unit 251-1 and/or the second display unit 251-2, an object (not illustrated) for sharing the image with another display unit (not illustrated) (e.g., a display unit provided for a rear seat occupant) may be displayed together with the image. If the object is touched through, for example, touch input, the image may be shared with the other display unit.

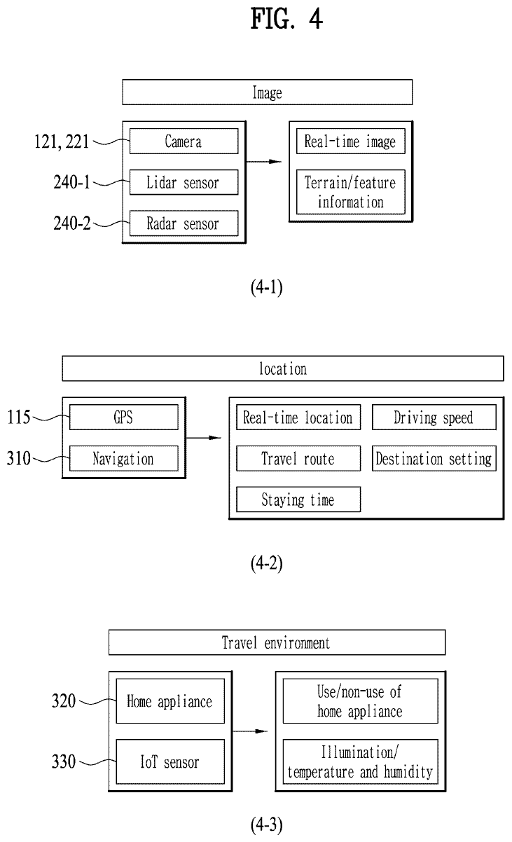

Hereinafter, collecting of movement data for providing user-customized tour guide content according to an aspect of the present disclosure will be described further with reference to FIG. 4. FIG. 4 illustrates an example of collection of movement data for providing user-customized tour guide content according to an aspect of the present disclosure.

As illustrated in (4-1) of FIG. 4, in order to obtain surrounding information of the user while the user is moving, the controller 180 of the user terminal 100 may obtain a real-time image and information about a place, a building, terrain, and/or a feature, around a user, using cameras 121 and 221, a lidar sensor 240-1, and a radar sensor 240-2. The lidar sensor 240-1 and the radar sensor 240-2 may be external devices that interwork with the user terminal 100 or may be built into the user terminal 100.

As illustrated in (4-2) of FIG. 4, in order to obtain location information of the user while the user is moving, the controller 180 may obtain real-time location information, driving speed information, and movement route information of the user, and staying time information of the user at a specific location using, for example, a GPS module (and/or Wi-Fi module). In addition, the controller 180 may set a desired destination of the user through a navigation application or program 310 in the user terminal 100 and may search for a travel route to the set destination and provide guidance on the travel route.

As illustrated in (4-3) of FIG. 4, in order to obtain information about a travel environment of the user, the controller 180 may obtain information about whether the user is using a home appliance in a moving vehicle or information about a current illumination level or current temperature and humidity in the vehicle by interworking with, for example, a home appliance 320 (e.g., a TV, an audio system, etc.) around the user and an Internet of Things (IoT) sensor 330 (e.g., an illuminance sensor, a temperature and humidity sensor, etc.).

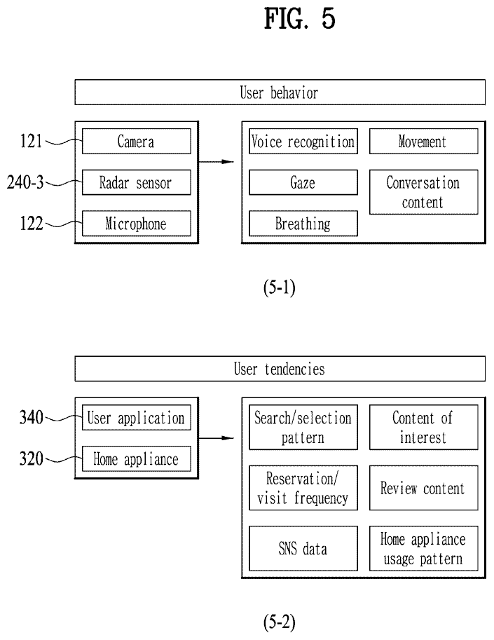

Hereinafter, collection of user data for providing user-customized tour guide content according to an aspect of the present disclosure will be described further with reference to FIG. 5. FIG. 5 illustrates an example of collection of user data for providing user-customized tour guide content according to an aspect of the present disclosure.

As illustrated in (5-1) of FIG. 5, in order to obtain information about user behavior while the user is moving, the controller 180 of the user terminal 100 may obtain information such as movement, gaze, breathing, etc. of the user using the camera 121 and a radar sensor 240-3. The camera 121 and the radar sensor 240-3 may be arranged to face the user. Therethrough, the controller 180 may determine, for example, whether the user is currently sleeping or is awake in the vehicle. In addition, the controller 180 may recognize voice of the user or the content of conversation through a microphone 122.

As illustrated in (5-2) of FIG. 5, the controller 180 may determine tendencies of the user (particularly, tendencies related to travel) by obtaining information about a search and selection pattern of the user, travel destination reservation and visit frequency, SNS data, content of interest, review content, and a home appliance usage pattern, using a usage history of a user application 340 and the home appliance 320.

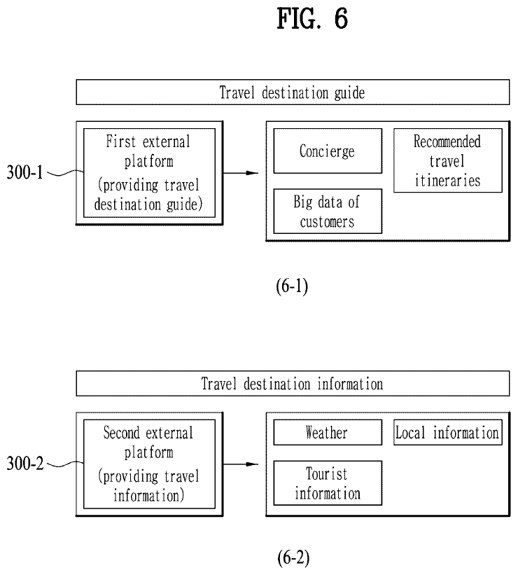

Hereinafter, collection of data about a travel destination (e.g., a tour point such as an object of a place, a building, terrain, and/or a feature) for providing user-customized tour guide content according to an aspect of the present disclosure will be described further with reference to FIG. 6. FIG. 6 illustrates an example of collection of tour point data for providing user-customized tour guide content according to an aspect of the present disclosure.

As illustrated in (6-1) of FIG. 6, the user terminal 100 may operate by interworking with a first external platform 300-1 that provides a travel destination guide through the wireless communication unit 110. Therethrough, the user terminal 100 may obtain information about recommended travel itineraries, concierge information available at a hotel to stay at a travel destination, and big data about travel information of other users from the first external platform 300-1.

As illustrated in (6-2) of FIG. 6, the user terminal 100 may operate by interworking with a second external platform 300-2 that provides travel destination information through the wireless communication unit 110. Therethrough, the user terminal 100 may obtain weather information, local information, and tourist information of a travel destination from the second external platform 300-2.

In FIG. 6, the first external platform 300-1 and the second external platform 300-2 are illustrated as being composed of separate entities. However, the first external platform 300-1 and the second external platform 300-2 do not necessarily have such a configuration. The first external platform 300-1 and the second external platform 300-2 may be integrated into one entity or be interconnected with each other, so that the information in FIG. 1 described as being provided by each of the first external platform 300-1 and the second external platform 300-2 may be provided through one integrated platform or different platforms.

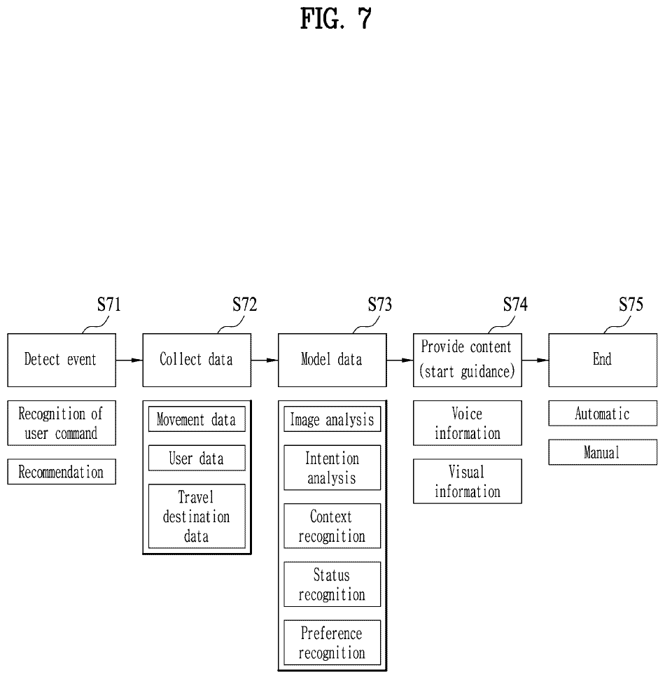

Hereinafter, a process for providing user-customized tour guide content according to an aspect of the present disclosure will be described further with reference to FIG. 7. FIG. 7 is a flowchart of a process for providing user-customized tour guide content according to an aspect of the present disclosure.

First, the controller 180 of the user terminal 100 may detect an event that triggers provision of tour guide content (S71). The event may, for example, recognizing input of a user command for requesting provision of the tour guide content. The user command may be input through a touch gesture on the display unit(s) 151 and/or 251 or through voice of the user through the microphone 122. Alternatively, the event may be an event recommending the tour guide content about a specific travel destination, received from the first external platform 300-1 or the second external platform 300-2 when the user reaches the specific travel destination, even without the user command. That is, the recommended event may be automatically generated by the first external platform 300-1 or the second external platform 300-2 and received therefrom.

Next, the controller 180 may collect various data for providing the user-customized tour guide content, i.e., movement data, user data, and travel destination data (S72). Since this is the same as previously described with reference to FIGS. 4 to 6, a detailed description will be omitted.

In FIG. 7, step S72 is illustrated as being performed after step S71. However, the order of these two steps may be changed, and in fact, the steps may be performed simultaneously from the perspective of the user.

Next, the controller 180 may model the data collected in step S72 in order to provide the user customized tour guide content (S73).

The controller 180 may identify an object such as a place, a building, terrain, and/or a feature, for example, within a predetermined radius (e.g., 5 km) from a current location by analyzing an image sensed in real time through the camera 221 and tag the identified object in the image with corresponding identification information (e.g., identification information of the place, the building, the terrain, and/or the feature). The object may include the tour point. The controller 180 may perform image processing so that an object related to provision of the tour guide content within the image is highlighted, dimmed, or 3D-rendered to be visually distinguished by analyzing the image sensed in real time through the camera 221.

The controller 180 may analyze intention of the user command for the object for which the user requests provision of the tour guide content by determining a time point at which the user requests provision of the tour guide content and the location of the user at that time point and thus identifying the object corresponding to the time point and the location of the user from the image. In particular, when the request of the user is made by voice, the controller 180 may recognize the voice through artificial intelligence and analyze intention of the user more accurately based on information about the recognized voice. The controller 180 may more accurately determine intention of the user command regarding for which object the user desires to receive the tour guide content based on the analyzed user intention.

The controller 180 may recognize context of utterance or conversation of the user which has been sensed before the user command is input by analyzing a voice spectrum of the user input through the microphone 122 through artificial intelligence and thus determining characteristics (e.g., gender, age, etc.) of the user. For example, when utterance or conversation of the user is “famous restaurant”, since criteria for “famous restaurant” may vary depending on the characteristics of the user, the recognition of the context is intended to consider the characteristics of the user. In addition, the controller 180 may analyze the frequency and content of mentions of a specific word in the utterance or conversation of the user to extract and store the topic and intention of the utterance or conversation of the user as a feature vector. Based on the analyzed context of the utterance or conversation of the user, the controller 180 may more accurately determine intention of the user command regarding for which object the user desires to receive the tour guide content.

The controller 180 may recognize information about a current status of the user by analyzing behavior and/or appearance of the user sensed through the camera 121 and the radar sensor 240-3 through artificial intelligence and analyzing the voice spectrum of the user input through the microphone 122 through artificial intelligence. That is, the information about the current status may include information about what the user is currently doing. In order to more accurately determine what the user is currently doing, the controller 180 may further determine a current status of the home appliance 320 manipulated by the user. For example, the controller 180 may more accurately determine whether the user is using the home appliance 320 and how the user is using the home appliance 320 if the user is using the home appliance 320. Therethrough, the controller 180 may identify which mode the user is currently in (e.g., one of sleep mode, rest mode, multitasking mode, do not disturb mode, etc.).

The controller 180 may recognize not only the status of the user but also the status of the vehicle in which the user is currently riding for travel. For example, the controller 180 may recognize real-time location information of the user, driving speed information, etc., using a GPS module. Additionally, the controller 180 may communicate directly with the vehicle and directly receive information about the status of the vehicle from the vehicle. The status of the vehicle may be used to determine, for example, the type and/or amount of the tour guide content provided to the user.

In addition, the controller 180 may analyze a travel pattern of the user and a service usage pattern while traveling through artificial intelligence based on accumulation data about places to which the user has traveled, a stayed period in each place, a place bookmarked by the user among the places, behavior and/or activities of the user in each place, information searched by the user in each place, and information that the user has shared in each place. The controller 180 may recognize preference of the user through the travel pattern of the user and the service usage pattern of the user while traveling. Based on the analyzed preference of the user, the controller 180 may more accurately determine intention of the user command regarding for which object the user desires to receive the tour guide content.

Analysis of the travel pattern and the service usage patterns while traveling may be independently performed with respect to different users through, for example, facial recognition. That is, even if two or more users use the user terminal 100, the user terminal 100 may individually analyze the travel pattern and the service usage pattern while traveling with respect to the two or more users.

In addition, the controller 180 may analyze big data about preferences of other users who use this service for providing the tour guide content and use an analyzed result in providing the tour guide content in each place. In other words, in providing the tour guide content, not only the preference of the user but also the preferences of other users may be considered based on the big data.

Next, the controller 180 may provide the user customized tour guide content (S74).

The provided content is created based on a result of modeling, in step S73, the data collected in step S72. Considering that the tour guide content is information about the object such as the tour point, the tour guide content may also be called object information. The tour guide content may be generated by the user terminal 100 itself. Alternatively, the tour guide content may be generated in a manner that identification information of the object is transmitted to the first external platform 300-1 and/or the second external platform 300-2, and text, sound, and/or image information corresponding to the identification information is received from the first external platform 300-1 and/or the second external platform 300-2. That is, the tour guide content may include at least one of the text, the sound, or the image information.

The provided content may be audio content through the audio output module 152 and/or visual content through the display unit(s) 151 and/or 251. The audio content and the visual content will be described again later.

Next, the controller 180 may automatically or manually provide the user-customized tour guide content (S74). That is, provision of the user-customized tour guide content may be manually ended by input of the user command by the user or may be automatically end when a preset event occurs even if the user does not input the user command. This will be described again later.

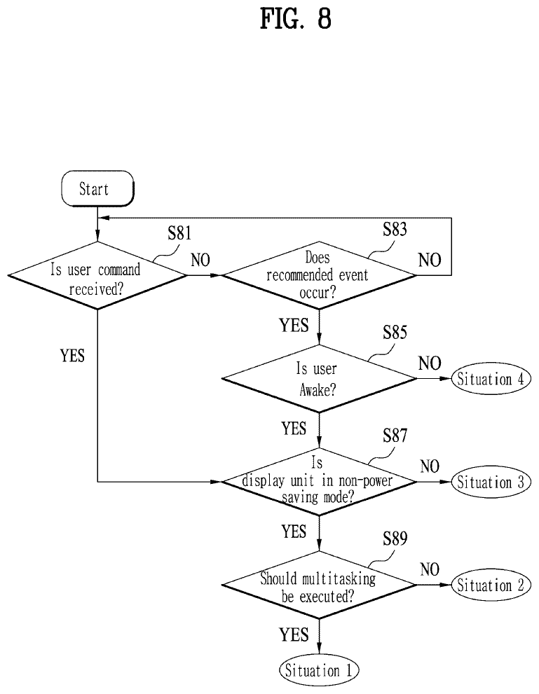

Hereinafter, a process for providing tour guide content in consideration of the status of the user according to an aspect of the present disclosure will be described further with reference to FIG. 8. FIG. 8 is a flowchart of a process for providing user-customized tour guide content according to one aspect of the present disclosure.

First, the controller 180 of the user terminal 100 may determine whether a user command for requesting provision of the tour guide content is received (S81). The user command may be input through a touch gesture on the display unit(s) 151 and/or 251 or through voice of the user through the microphone 122.

If it is determined that there is a user command in step S81, the process proceeds to step S87 which will be described below.

If it is determined that there is no user command in step S81, the controller 180 may determine whether an event recommending the tour guide content occurs (S83). The event may be an event recommending the tour guide content about a specific travel destination, received from the first external platform 300-1 or the second external platform 300-2 when the user reaches the specific travel destination, even without the user command. That is, the recommended event may be automatically generated by the first external platform 300-1 or the second external platform 300-2 and received therefrom.

While step S82 has been described as being performed after step S81, step S81 does not necessarily have to be performed before step S82.

If it is determined that the recommended event does not occur in step S83, the process proceeds to step S81.

However, if it is determined that the recommended event occurs in step S83, the controller 180 may determine whether the user is awake, that is, not falling asleep (S85). That is, the controller 180 may determine whether the user moving in the vehicle for a trip is currently sleeping or not sleeping. As described above, the controller 180 may identify whether the user is sleeping or not sleeping by obtaining information such as movement, gaze, or breathing of the user using the camera 121 and the radar sensor 240-3 arranged to face the user.

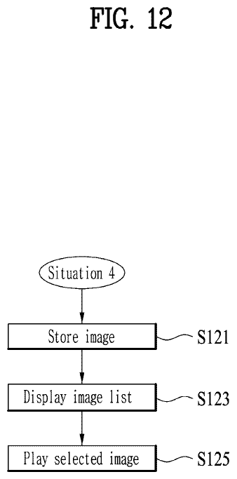

If it is determined that the user is sleeping in step S85, the controller 180 determines that a current situation is situation 4. Provision of the tour guide content in situation 4 is described later in FIG. 12.

If it is determined that the user is not sleeping in step S85, the controller 180 may determine whether the display unit(s) 151 and/or 251 is in a power saving mode or a non-power saving mode. The power saving mode may include a power-off mode of the display unit, a deactivation mode, and an always on display (AOD) mode.

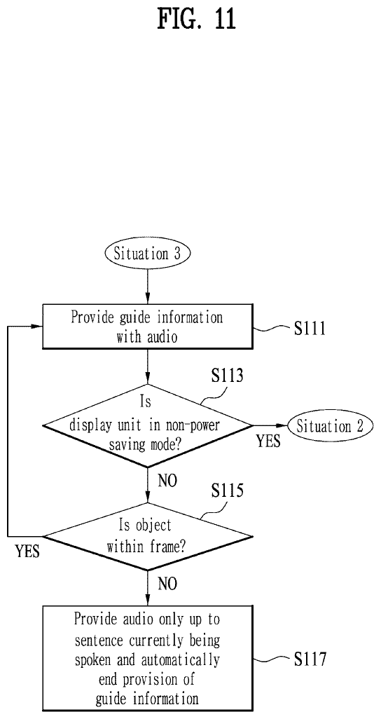

If it is determined that the display unit(s) 151 and/or 251 is in the power saving mode in step S87, the controller 180 determines that the current situation is situation 3. Provision of the tour guide content in situation 3 is described later in FIG. 11.

If it is determined that the display unit(s) 151 and/or 251 is in the non-power saving mode in step S87, the controller 180 determines whether another application (or program) is already being executed in the foreground of the user terminal 100 (S89). That is, if the tour guide content has been provided and displayed because the other application is already being executed in the foreground, the controller 180 may determine whether multitasking should be executed.

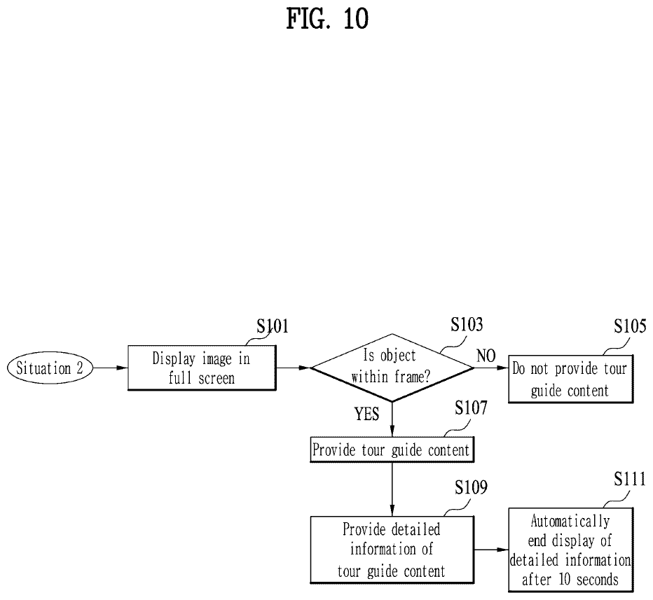

If it is determined in step S85 that there is no application executed in the foreground, the controller 180 determines that the current situation is situation 2. Provision of the tour guide content in situation 2 is described later in FIG. 10.

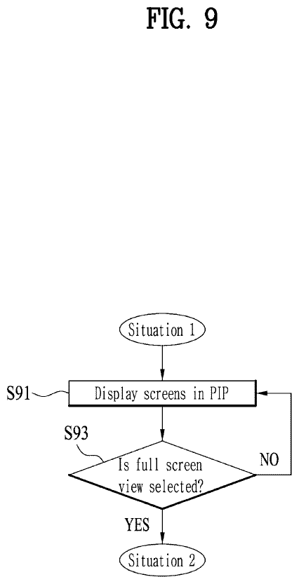

If it is determined in step S85 that there is an application being executed in the foreground, the controller 180 determines that the current situation is situation 1. Provision of the tour guide content in situation 1 is described below in FIG. 9.

Hereinafter, provision of the tour guide content in situation 1 will be described further with reference to FIG. 9. FIG. 9) is a flowchart of a process for providing user-customized tour guide content in situation 1 of FIG. 8.

The controller 180 may perform a control operation to simultaneously display a screen of the tour guide content and a screen of the application being executed in the foreground by splitting the screen of the display unit(s) 151 and/or 251 (S91). There are no restrictions on screen splitting of the display unit(s) 151 and/or 251. For example, the display unit(s) 151 and/or 251 may be screen-split using a picture-in-picture (PIP) function, so that the execution screen of the application being executed in the foreground may be displayed in the larger area of the two split screen areas of the display unit(s) 151 and/or 251, and the screen of the tour guide content may be displayed in the smaller area thereof.

Next, the controller 180 may determine whether a user command for displaying the screen related to the tour guide content is input (S93). The user command may be input through a touch gesture on the display unit(s) 151 and/or 251 or through voice of the user through the microphone 122. Here, if the screen related to the tour guide content is displayed in full screen, this means that the screen related to the tour guide content is displayed to occupy a considerable area of the display unit(s) 151 and/or 251 when the user glances at the screen of viewed by the user of the display unit(s) 151 and/or 251 without displaying an execution screen of another application or a playback screen of another content but does not necessarily mean that the screen related to the tour guide content should be displayed to occupy 100% of the area of the display unit(s) 151 and/or 251.

If it is determined in step S93 that the user command for displaying the screen related to the tour guide content in full screen is input, the controller 180 may provide the screen related to the tour guide content according to situation 2.

However, if it is determined in step S93 that the user command for displaying the screen related to the tour guide content in full screen is not input, the controller 180 may perform a control operation to simultaneously display the screen of the tour guide content and the screen of the application being executed in the foreground while maintaining screen splitting of the display unit(s) 151 and/or 251 (S91).

Hereinafter, provision of tour guide content in situation 2 will be described further with reference to FIG. 10. FIG. 10 is a flowchart of a process for providing user-customized tour guide content in situation 2 of FIG. 8.

The controller 180 may control the display unit(s) 151 and/or 251 to display the image sensed in real time by the at least one external camera 221 in full screen (S101).

Next, the controller 180 may determine whether a tour point such as an object of a place, a building, terrain, and/or a feature corresponding to a popular tourist spot or travel destination in the image is within a frame of the image sensed in real time (S103).

If it is determined in step S103 that the tour point is not within the frame, the controller 180 may not display tour guide content for the tour point (S105).

If it is determined in step S103 that the tour point is within the frame, the controller 180 may display the tour guide content for the tour point together with the real-time image (S107). The tour guide content displayed here may be tour guide content of a simplified version. The tour guide content may be displayed only while the tour point exists within the frame. Alternatively, the tour guide content may not be displayed after a predetermined time has elapsed from a time point at which the tour point is included within the frame, even if the tour point is within the frame.

Next, while the tour guide information is being displayed, the controller 180 may receive a user command requesting that detailed information of the tour guide content (i.e., the tour guide content of a detailed version) be displayed. The user command may be input through a touch gesture on the display unit(s) 151 and/or 251 or through voice of the user through the microphone 122.

Then, the controller 180 may display the detailed information of the tour guide content. The detailed information may be displayed in full screen without the real-time image or may be displayed together with the real-time image by being overlaid on the real-time image (S109).

The controller 180 may perform a control operation so that the detailed information automatically disappears after the detailed information is displayed for a predetermined time (e.g., 10 seconds). The detailed information may continue to be displayed for the predetermined time even if the tour point disappears from the frame.

Hereinafter, provision of tour guide content in situation 3 will be described further with reference to FIG. 11. FIG. 11 is a flowchart of a process for providing user-customized tour guide content in situation 3 of FIG. 8.

If the tour point is within the frame, the controller 180 may provide tour guide information only with audio through the audio output unit 152 (S111).

The controller 180 may determine whether a user command for switching the display unit(s) 151 and/or 251 to a non-power saving mode is input (S113). The user command may be input through a touch gesture on the display unit(s) 151 and/or 251 or through voice of the user through the microphone 122.

If it is determined in step S113 that the user command for switching the display unit(s) 151 and/or 251 to the non-power saving mode is input, the controller 180 may provide the tour guide content according to situation 2 of FIG. 10 described above.

However, if it is determined in step S113 that the user command for switching the display unit(s) 151 and/or 251 to the non-power saving mode is not input, the controller 180 may determine whether the tour point remains within the frame (S115).

If it is determined in step S115 that the tour point is within the frame, the controller 180 may continue to provide the tour guide information only with audio (S111).

However, if it is determined in step S115 that the tour point has disappeared from the frame (i.e., it is determined that the tour point has exited the frame), the controller 180 may perform a control operation to provide audio only up to a sentence currently being spoken and then not to provide the guide information any longer (S117).

Hereinafter, provision of tour guide content in situation 4 will be described further with reference to FIG. 12. FIG. 12 is a flowchart of a process for providing user-customized tour guide content in situation 4 of FIG. 8.

The controller 180 may store real-time images including the tour point (S121). That is, the controller 180 may record the real-time images from a moment at which the tour point enters the frame or from a predetermined time (e.g., 5 seconds) before the frame enters the frame until a moment at which the tour point leaves the frame or until a predetermined time (e.g., 5 seconds) after the tour point disappears from the frame. Next, the controller 180 may store the recorded real-time images in the memory 170

Thereafter, the controller 180 may display an image list. For example, the image list may be displayed when a user command is input (S123). The image list may include the recorded real-time images.

When a user command for selecting one image from the image list is input, the controller 180 may play the selected image and display the image on the display unit(s) 151 and/or 251.

The user command for displaying the image list and the user command for selecting one image from the image list may be input through a corresponding touch gesture on the display unit(s) 151 and/or 251 or may be input by the user through the microphone 122.

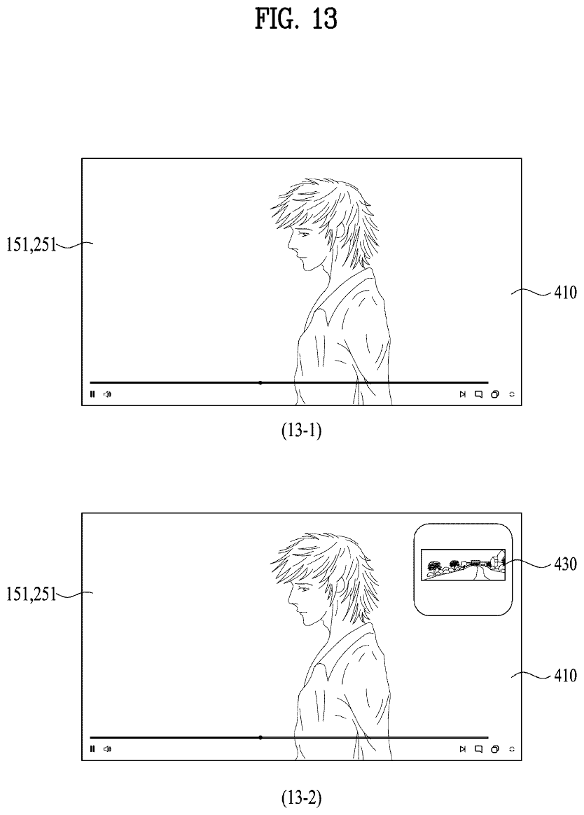

Hereinafter, provision of the tour guide content in situation 1 will be described in more detail with reference to FIG. 13. FIG. 13 illustrates a display screen providing the tour guide content in situation 1 of FIG. 9.

As illustrated in (13-1) of FIG. 13, the controller 180 may display, in full screen on the display unit(s) 151 and/or 251, an execution screen 410 of an application being executed in the foreground. In FIG. 13, the application being executed in the foreground is a video playback application, and the execution screen 410 of the application is a video (e.g., movie) playback screen.

While the execution screen 410 is being displayed on the display unit(s) 151 and/or 251, a user command for requesting provision of tour guide content is received from the user terminal 100, or an event recommending the tour guide content may occur. Hereinafter, the reception of the user command for requesting provision of the tour guide content and the occurrence of the event recommending the tour guide content will be collectively referred to as a “triggering event providing tour guide content”.

Then, as illustrated in (13-2) of FIG. 13, the controller 180 may perform a control operation to simultaneously display the execution screen 410 of the application and a tour guide content screen 430 by splitting the screen of the display unit(s) 151 and/or 251 in a PIP method. Therefore, as illustrated, the execution screen 410 of the application is displayed in the larger area of two split screen areas of the display unit(s) 151 and/or 251, and the tour guide content screen 430 is displayed in the smaller area thereof.

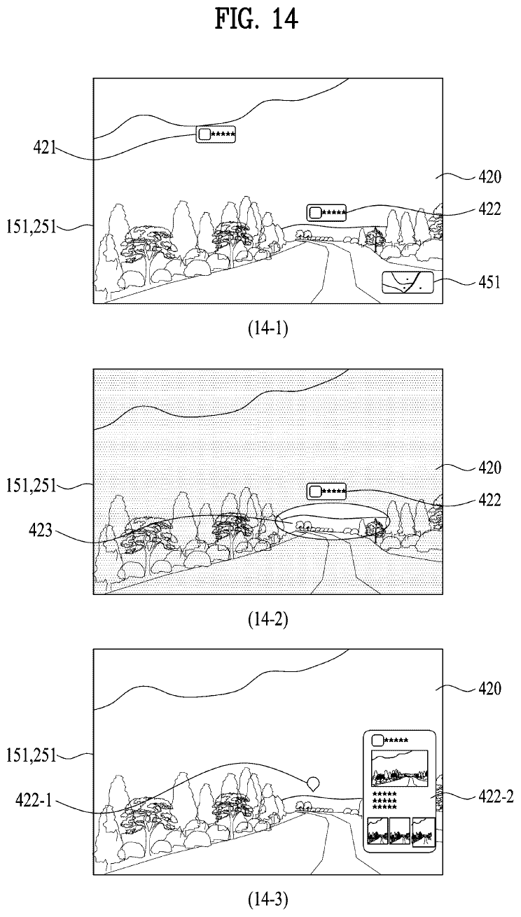

For example, when the screen 430 of the tour guide content is touched and selected, the controller 180 display the tour guide content in full screen as illustrated in (14-1), (14-2), or (14-3) of FIG. 14, which will be described below.

Hereinafter, provision of the tour guide content in situation 2 will be described in more detail with reference to FIG. 14. FIG. 14 illustrates a display screen providing the tour guide content in situation 2 of FIG. 10.

As illustrated in (14-1) of FIG. 14, the controller 180 may control the display unit(s) 151 and/or 251 to display an image 420 sensed in real time by the at least one external camera 221 in full screen.

Additionally, the controller 180 may display a plurality of tour point indicators 421 and 422 indicating tour points and a navigation map 451 within the image 420. The tour point indicators 421 and 422 and/or the navigation map 451 may also be understood as belonging to the tour guide content. The tour point indicators 421 and 422 may be displayed to correspond to the tour points in the image in an AR or XR manner. The tour point indicators may include only brief information (e.g., the names of tourist spots or travel destinations) of the tour points. The brief information of the tour points may be understood as simplified versions of the tour guide content.

The controller 180 does not necessarily display all of the plurality of tour point indicators 421 and 423. Considering tendencies of the user, the controller 180 may display only a tour point indicator 422 corresponding to a tour point 423 that best matches the tendencies of the user, as illustrated in (14-2) of FIG. 14. In this case, the remaining area excluding the tour point 423 and the indicator 422 of the tour point 423 may be dimmed in the screen in which the tour guide content is displayed, or the tour point 423 and the indicator 422 of the tour point 423 may be highlighted so that the tour point 423 and the indicator 422 of the tour point 423 are displayed to be visually prominent, i.e., visually identifiable.

One tour point indicator 422 may be selected in (14-1) or (14-2) of FIG. 14. The selection may be made through a touch gesture on the display unit(s) 151 and/or 251 or through voice of the user through the microphone 122.

Then, the controller 180 may display detailed content 422-2 of the tour point 423, as illustrated in (14-3) of FIG. 14. The detailed content 422-2 may include more detailed information (e.g., a detailed description of a tourist spot or travel destination) in addition to the brief information. In addition, the tour point indicator 422 may be converted to a minimized indicator 422-1 and displayed.

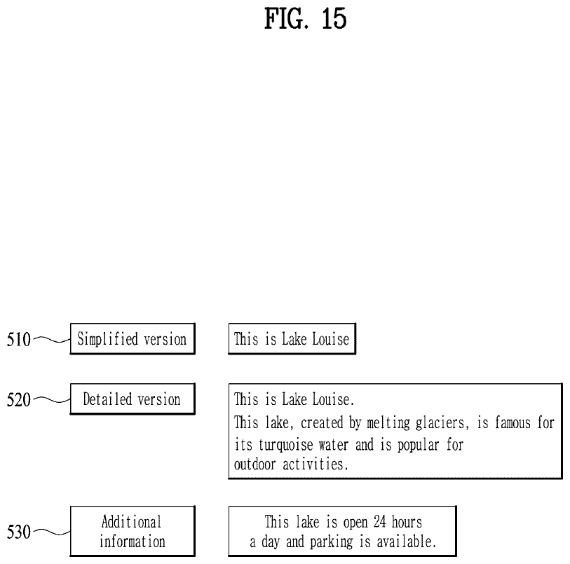

Hereinafter, provision of tour guide content in situation 3 will be described in more detail with further reference to FIG. 15. FIG. 15 illustrates an example of the tour guide content provided in situation 3 of FIG. 11.

If the tour point is within a frame, the controller 180 may provide tour guide information only with audio through the audio output unit 152. In this case, the controller 180 may provide different versions of tour guide information for the same tour point according to the movement speed of the user (or a vehicle in which the user rides).

If the movement speed of the user is higher than a first speed (e.g., 80 km per hour), the controller 180 may provide tour guide information 510 of a simplified version. The reason why the tour guide information 510 of the simplified version is provided is to provide the tour guide information 510 before the user completely passes the tour point because the user will pass the tour point quickly when the movement speed exceeds a certain speed.

If the movement speed of the user is less than the first speed, the controller 180 may provide tour guide information 520 of a detailed version (or detailed information about the tour guide content). The reason why the tour guide information 520 of the detailed version is provided is to sufficiently provide information about the tour point during a sufficient time because the user will pass the tour point slowly and it takes a certain amount of time to completely pass the tour point when the movement speed is less than a certain speed.

Meanwhile, if the user still has not completely passed the tour point even though the detailed version of the tour guide information 520 is provided, the controller 180 may provide additional information 530 about the tour point.

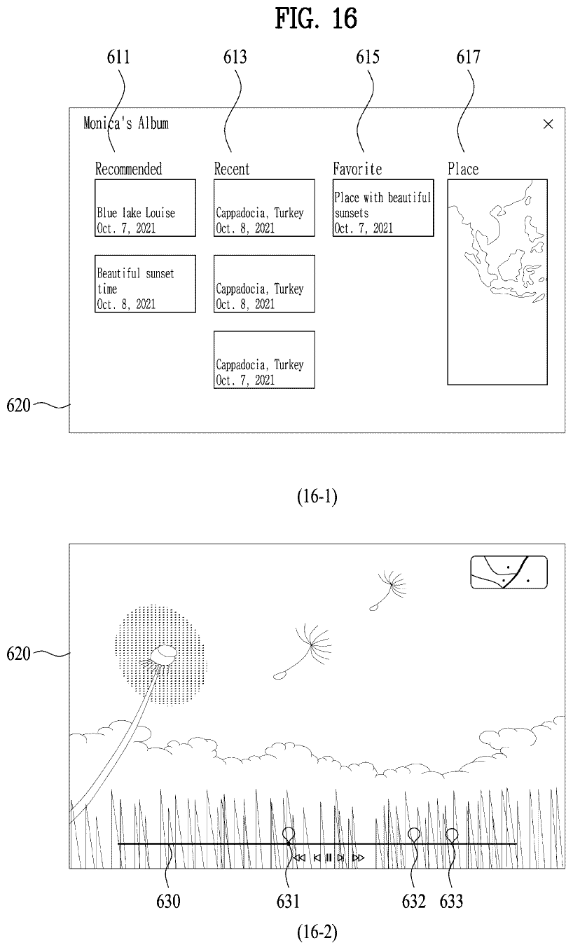

Hereinafter, provision of the tour guide content in situation 4 will be described in more detail with reference to FIG. 16. FIG. 16 illustrates an example of the tour guide content provided in situation 4 of FIG. 12.

In situation 4, the controller 180 may record real-time images including the tour points and store the images in the memory 170. The recorded real-time images may include both the tour point indicators and related information.

As illustrated in (16-1) of FIG. 16, the controller 180 may display an image list 610.

The image list 610 includes at least one image classified as a recommended category 611, at least one image classified as a recent category 613, at least one image classified as a favorite category 615, and at least one image classified as a place category 617.

The recorded image may be classified as at least one category among the plurality of categories and stored in the image list 610.

When a user command for selecting an image from the image list 610 is input, the controller 180 plays the selected image and displays a playback screen 620 on the display unit(s) 151 and/or 251, as illustrated in (16-2) of FIG. 16.

The controller 180 may display a progress bar 630 for controlling playback of the selected image in the playback screen 620.

At least one bookmark indicator 631, 632, or 633 may be displayed on the progress bar 630 to correspond to a time point when the tour point appears. Accordingly, when one of the bookmark indicators is selected, an image of a time point when a tour point corresponding to the selected bookmark indicator is included may be played immediately. When the image of the time point when the tour point is included is played, a corresponding tour point indicator and related information may be displayed together.

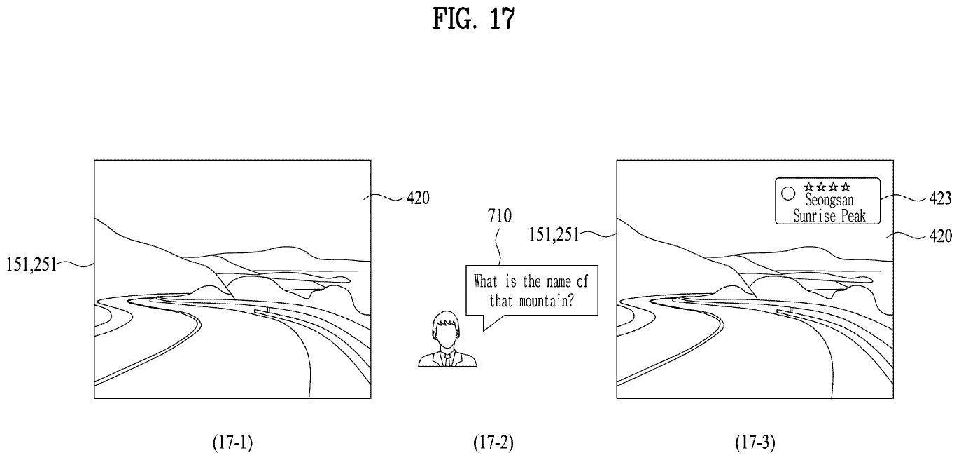

Hereinafter, displaying the tour guide content at the request of the user will be described in more detail with reference to FIG. 17. FIG. 17 illustrates a screen in which the tour guide content provided according to FIG. 7 is displayed.

As illustrated in (17-1) of FIG. 17, the controller 180 may perform a control operation to display the real-time image 420) (sensed in real time by the at least one external camera 221) on the display unit(s) 151 and/or 251.

While the real-time image 420 is being displayed, a triggering event may occur in the user terminal 100. The triggering event occurs when the controller 180 recognizes input of a voice command 710 of the user for requesting provision of tour guide content through the microphone 122, as illustrated in (17-2) of FIG. 17.

Then, the controller 180 may generate user-customized tour guide content for a tour point based on a result of modeling, in step S73, the data collected in step S72. That is, even if there is an unclear part in the voice command 710, the controller 180 may understand the context of the voice command of the user based on the result of modeling, in step S73, the data collected in step S72 and provide the user-customized tour guide content.

The controller 180 may perform a control operation to display information 423 of the tour guide content, as illustrated in (17-3) of FIG. 17. The displayed tour guide content is a simplified version and may display only simplified information. The display size of the tour guide content information 423 may vary depending on a distance between the tour point and the user. For example, as the distance between the user and the tour point becomes close, the display size of the information 423 of the tour guide content may increase.

Detailed tour guide content for the tour point may be displayed by selecting the simplified information 423 as described above.

However, the detailed tour guide content does not necessarily need to be provided if the simplified information 423 is selected after the simplified information 423 is displayed first.

For example, if the movement speed of the user is less than a predetermined speed upon occurrence of a triggering event, the detailed tour guide content may be displayed, and if the movement speed of the user is equal to or greater than the predetermined speed, the simplified information may be displayed.

The controller 180 may perform a control operation to end display of the tour guide content when the tour point exit a frame of the real-time image.

It is apparent that the controller 180 may perform a control operation to end display of the tour guide content in response to a user command even if the tour point does not exit the frame of the real-time image.

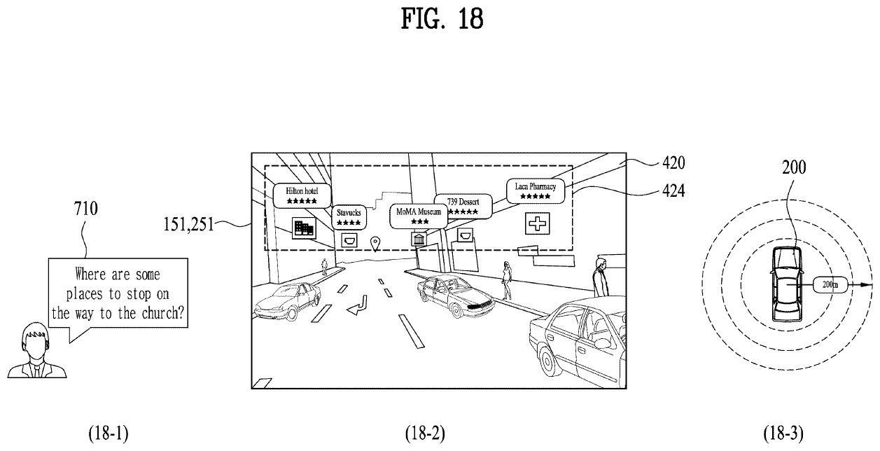

Meanwhile, even though the tour point is included within the frame of the real-time image, the tour guide content for the tour point may not necessarily be displayed. This will be described further with reference to FIG. 18. FIG. 18 illustrates an example of a distance range in which tour guide content is displayed according to an aspect of the present disclosure.

As illustrated in (18-1) and (18-2) of FIG. 18, a triggering event may occur in the user terminal 100 while the real-time image 420 is being displayed. The occurrence of the triggering event may mean that the controller 180 recognizes input of the voice command 710 of the user for requesting provision of tour guide content through the microphone 122.

Then, the controller 180 may perform a control operation to generate a plurality of tour guide content corresponding to a plurality of tour points based on the result of modeling, in step S73, the data collected in step S72 and display the plurality of tour guide content (e.g., simplified information) 424.

The plurality of tour points may be some of all tour points that exist within a frame of the real-time image. For example, as illustrated in (18-3) of FIG. 18, the plurality of tour points may be located within a predetermined radius distance (e.g., 200 m) from the user or a vehicle 200 in which the user is riding, among all tour points that exist within the frame of the real-time image.

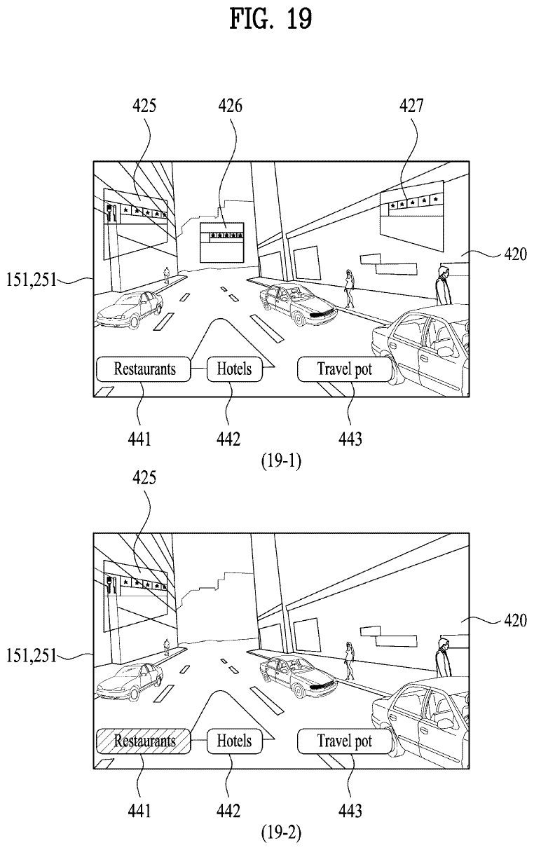

However, even if a distance is limited to the predetermined radius, in the case of, for example, a famous travel spot or tourist destination, there may be too many tour points within the frame of the real-time image to be displayed on the display unit(s) 151 and/or 251. In this case, a method of effectively displaying tour guide content for the tour points will be described further with reference to FIG. 19. FIG. 19 illustrates an example of selecting a type of tour guide content according to an aspect of the present disclosure.

As illustrated in (19-1) of FIG. 19, the controller 180 may display a plurality of tour guide content 425, 426, and 427 for a plurality of tour points while displaying the real-time image 420 on the display unit(s) 151 and/or 251.

In addition, the controller 180 may display tour point type icons 441, 442, and 443 for determining the types of the tour points desired by the user together with the plurality of tour guide content 425, 426, and 427. Each tour point type icon is an on/off toggle switch type, and whenever each icon is touched and selected, selection and deselection of a corresponding tour object type may be toggled. Accordingly, the user may toggle the tour point type icons 441, 442, and 443 in order to determine a desired type of tour point.

The controller 180 may perform a control operation to selectively display only tour guide content corresponding to at least one tour point type selected through the tour point type icons 441, 442, and 443 together with the real-time image 420.

In (19-2) of FIG. 19, only the “restaurant” type icon 441 is selected from among the plurality of tour point type icons 441, 442, and 443, and only the tour guide content 425 of the tour point corresponding to the selected “restaurant” type icon 441 is displayed.

While limiting the number of displayed tour guide content based on the distance and/or the tour point type has been described, the present disclosure is not limited thereto. For example, the number of tour guide content that may be displayed is limited to a predetermined number (e.g., 10), and if the tour guide content to be displayed exceeds the predetermined number, tour guide content that has been displayed for a long time may be configured to be sequentially deleted.

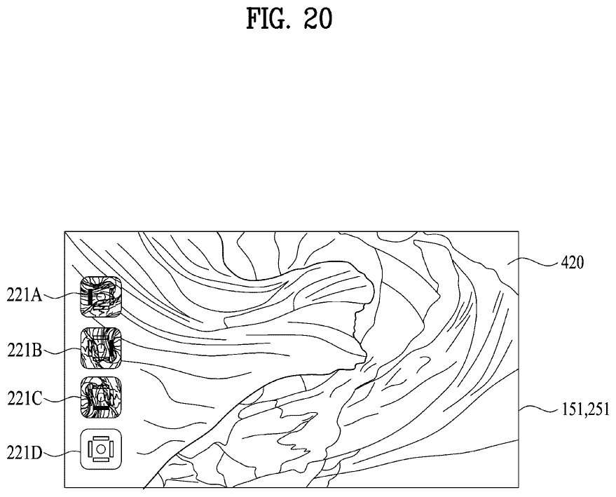

The real-time video displayed as the tour guide content on the display unit(s) 151 and/or 251 has been described hereinabove. However, as illustrated in FIG. 3, the user terminal 100 may operate by interworking with a plurality of external cameras, i.e., the front camera 221-1, the right camera 221-2, the left camera 221-3, and the rear camera 221-4. In this case, an image sensed in real time by a camera selected by the user from among the four cameras may be displayed as a main image on the display unit(s) 151 and/or 251. This will be described further with reference to FIG. 20. FIG. 20 illustrates an example of selecting a real-time image to be displayed according to an aspect of the present disclosure.

As illustrated in FIG. 20, the controller 180 may perform a control operation to display camera icons 221A, 221B, 221C, and 221D corresponding respectively to the four cameras 221-1, 221-2, 221-3, and 221-4 on the display unit(s) 151 and/or 251.

When one of these icons is touched and selected, the controller 180 may perform a control operation to display the image 420) sensed in real time by a camera corresponding to the selected icon as a main image on the display unit(s) 151 and/or 251.

Hereinabove, the triggering event providing tour guide content has been described as including receipt of the user command for requesting provision of the tour guide content and occurrence of the event recommending the tour guide content.

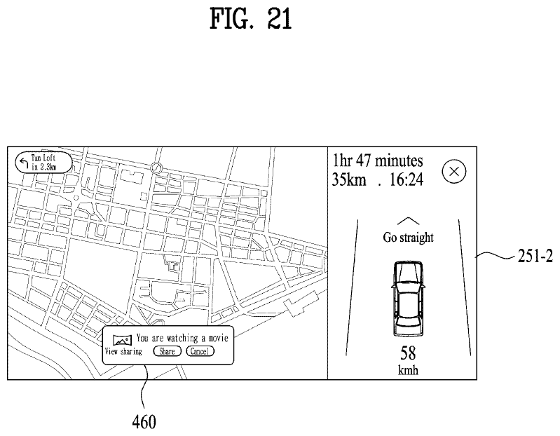

However, the triggering event providing the tour guide content may not be limited thereto. For example, the driver of the vehicle 200 may trigger whether to provide the tour guide content to a passenger sitting in a rear seat of the vehicle 200 using the user terminal 100. This will be described further with reference to FIG. 21. FIG. 21 illustrates an example of sharing tour guide content according to an aspect of the present disclosure.

To be more specific, the vehicle 200 and the user terminal 100 may interwork with each other. In this case, if the driver desires to share tour guide content about a certain tour point visible ahead from a current location with the passenger, the driver may manipulate the user input unit 223 (e.g., a button, a dome switch, a jog wheel, a jog switch, a touch input means, etc.) provided on the steering wheel of the vehicle. Then, a control signal for triggering provision of the tour guide content may be provided from the vehicle 200 to the user terminal 100.

The user terminal 100 may provide the tour guide content described above to the passenger based on the control signal.

Meanwhile, the user terminal 100 may provide information about a current situation determined according to FIG. 8 to the vehicle 200. As illustrated in FIG. 21, the vehicle 200 may display information 460 about the current situation on the display unit 251-2 of the digital dashboard of the vehicle 200.

Accordingly, the driver may determine whether to share the tour guide content with the passenger with reference to the displayed information 460 about the current situation.

As described with reference to FIGS. 8 and 12, whether to store the real-time image has been described as being determined depending on whether the user is in a non-sleeping state. In addition, as described above with reference to FIGS. 8 and 10, whether to display tour guide content for a tour point has been described as being determined depending on whether the tour point exists within a frame of a currently displayed real-time image.

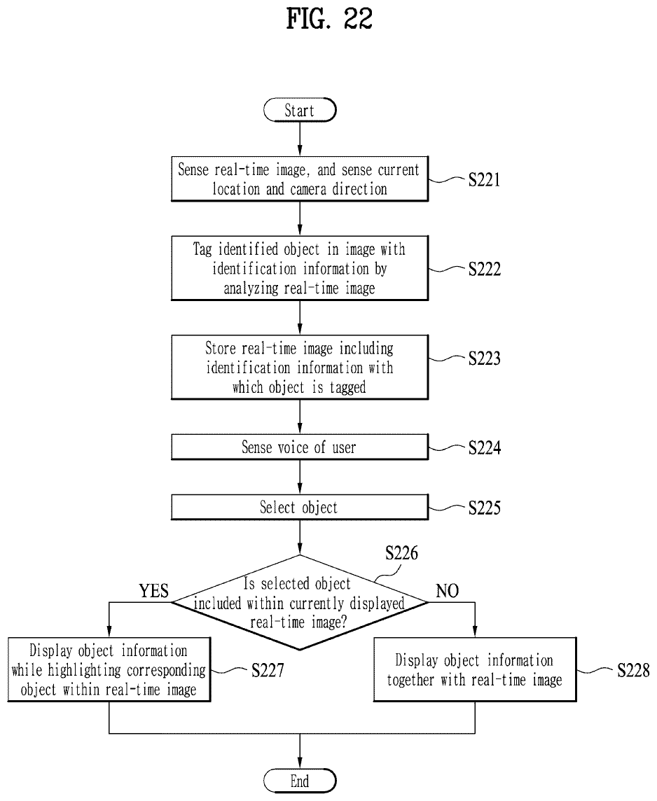

However, the present disclosure is not limited thereto. The real-time image may be stored regardless of whether the user is in a non-sleeping state, and the tour guide content for the tour point may be displayed regardless of whether the tour point is within the frame of the currently displayed real-time image. This will be described further with reference to FIG. 22.

The controller 180 may sense an image in real time through the external camera 221 and sense information about the location of the user terminal 100 and the direction of the user terminal 100 (i.e., the direction of the external camera 221) through the location information module 115 (S221).

The controller 180 may analyze a plurality of objects included within the real-time image through analysis of the real-time image.

The controller 180 may identify at least one object, such as a place, a building, terrain, and/or a feature, within the image by analyzing the image sensed in real time, i.e., the real-time image, and tag each identified object with corresponding identification information (e.g., the name of the object) for each frame of the real-time image (S222). The object may include the tour point described above.

In addition, the controller 180 may store, in the memory 170, the real-time image including the identification information with which the at least one object is tagged (S223).

The controller 180 may sense a triggering event (S224). For example, sensing the triggering event may mean that the controller 180 recognizes input of a voice command of the user for requesting provision of tour guide content through the microphone 122.

Then, the controller 180 may select an object corresponding to the triggering event (S225). When the triggering event is the voice command of the user, the controller 180 may select an object corresponding to the voice command in consideration of the location and direction of the user terminal 100. In addition, when selecting the object, the controller 180 may further utilize collection of the data in step S72 and modeling of the data in step S73 of FIG. 7 described above.

The controller 180 may determine whether the selected object is included within a real-time image currently displayed on the display unit 151 (S226).

As a result of the determination, if the selected object is within the real-time image, the controller 180 may display object information corresponding to the object while processing the image so that the object is highlighted within the image. The object information may include the tour content information. Highlighting the object within the image means that the object is visually distinguished from other objects within the real-time image, and there are no limitations to an image processing method for visual distinction. For example, graphics only for the object may be displayed, and only the object may be imaged brightly compared to other objects.

The object information may be generated by the user terminal 100 itself. Alternatively, the object information may be generated in a manner that identification information of the object is transmitted to the first external platform 300-1 and/or the second external platform 300-2, and text, sound, and/or image information corresponding to the identification information is received from the first external platform 300-1 and/or the second external platform 300-2. That is, the object information may include at least one of the text, the sound, or the image information.

The controller 180 may perform a control operation to vary a location at which the object information is displayed on the display unit 151 depending on a location at which the object is displayed within the image.

For example, a display position of the object information may be determined to be adjacent to the object within a range in which the object information does not obscure the object in the image, so that the object information may be displayed to be overlaid on the real-time image.

As a result of the determination, when the selected object is not within the real-time image, the controller 180 may perform a control operation to display the object information together with the real-time image at a preset location. In this case, highlight image processing may not be performed for any object within the real-time image in response to voice of the user. For example, the object information may be displayed on the display unit 151 in a pop-up window, PIP, or screen splitting manner.

The object information may be generated by the user terminal 100 itself. Alternatively, the object information may be generated in a manner that identification information of the object is transmitted to the first external platform 300-1 and/or the second external platform 300-2, and text, sound, and/or image information corresponding to the identification information is received from the first external platform 300-1 and/or the second external platform 300-2. That is, the object information may include at least one of the text, the sound, or the image information.

Meanwhile, when the selected object is not within the real-time image, the controller 180 may search for a duration in which the identification information related to the selected object is tagged in the stored real-time image and play a clip of the real-time image of the searched duration together with the object information. However, if the selected object is within the real-time image, the controller 180 may not play the clip of the real-time image in the searched duration upon displaying the object information.

Meanwhile, when the object information is displayed as illustrated in FIG. 21, all of the object information (tour guide content) display methods described above may be applied. For example, the following methods may be applied.

According to the movement speed of the user, object information (tour guide content) of different types (simplified version/detailed version) may be displayed. When the movement speed is equal to or greater than a certain speed, the object information of the detailed version may be displayed, and when the movement speed is less than the certain speed, the object information of the simplified version may be displayed. If the object information is selected while the object information of the simplified version is displayed, the object information of the detailed version may be displayed.

If an event triggering provision of the object information occurs while an execution screen of another application which is being executed in the foreground is being displayed on the display unit, a screen of the display unit is split to simultaneously display an object information screen and the execution screen of the other application. The real-time image may also be displayed in the object information screen.

When the object information screen is selected by the user, the real-time image and the object information may be displayed in full screen.

If the display is in a power saving mode when the event triggering provision of the object information occurs, the object information may be output only with audio through the audio output unit. When the display unit switches from the power saving mode to a non-power saving mode, the real-time image and the object information may be displayed in full screen.

When the object information is output only with audio in the power saving mode, different types of audio may be output according to the movement speed of the user. If the movement speed is equal to or greater than a certain speed, audio of the object information of a simplified version may be output, and if the movement speed is less than the certain speed, audio of the object information of a detailed version may be output.

A plurality of object information for a plurality of objects may be displayed together with a plurality of object type icons. When at least one of the plurality of object type icons is selected by the user, only object information of at least one object corresponding to the selected at least one object type icon among the plurality of object information may be displayed.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. The present teachings can be readily applied to other types of methods and apparatuses. The scope of the disclosure should be determined by reasonable interpretation of the appended claims and all changes coming within the equivalency range of the disclosure are intended to be embraced in the scope of the disclosure.

1. A user terminal, comprising:
a display unit;
a microphone;
a location information module;
a camera; and
a controller configured to
display a real-time image sensed through the camera on the display unit,
analyze, in real time, a plurality of objects included within the real-time image through analysis of the real-time image and select an object corresponding to voice of a user by analyzing, through artificial intelligence, at least one of a current location and a direction sensed through the location information module and the voice of the user input through the microphone,
display the real-time image and selected object information of the selected object together while highlighting the selected object within the real-time image, based on the selected object being included within the real-time image currently displayed on the display unit, and
display the real-time image and the selected object information together without highlighting the selected object, based on the selected object being not included within the real-time image currently displayed on the display unit.

2. The user terminal of claim 1, wherein, based on the selected object being included within the real-time image currently displayed, the controller performs a control operation to vary a location at which the selected object information is displayed on the display unit depending on a location of the selected object within the real-time image.

3. The user terminal of claim 1, wherein, based on the selected object being not included within the real-time image currently displayed, the controller performs a control operation to display the selected object information at a preset location of the display unit.

4. The user terminal of claim 1, further comprising a memory,
wherein the controller performs a control operation to identify at least one object among the plurality of objects within the real-time image, tag the identified object with identification information, and store, in the memory, the real-time image including the identification information with which the at least one object is tagged.

5. The user terminal of claim 4, wherein, based on the selected object being not within the real-time image currently displayed, the controller performs a control operation to search for a duration in which the identification information related to the selected object is tagged in the stored real-time image and play a clip of the real-time image of the searched duration together with the selected object information.

6. The user terminal of claim 5, wherein, based on the selected object being included within the real-time image currently displayed, the controller performs a control operation not to play the clip of the real-time image of the searched duration upon displaying the selected object information.

7. The user terminal of claim 1, further comprising a wireless communication unit,
wherein the controller performs a control operation to
transmit identification information of the selected object to an external platform through the wireless communication unit,
receive at least one of text, sound, or image information related to the identification information through the wireless communication unit from the external platform, and
include the at least one of the text, the sound, or the image information in the selected object information.

8. The user terminal of claim 1, wherein the controller performs a control operation to display selected object information of different types according to a movement speed of the user.

9. The user terminal of claim 8, wherein the controller performs a control operation to
display the selected object information of a detailed version based on the movement speed being equal to or greater than a certain speed, and
display the selected object information of a simplified version based on the movement speed being less than the certain speed.

10. The user terminal of claim 9, wherein, based on the selected object information of the simplified version being selected by the user, the controller performs a control operation to display the selected object information of the detailed version.

11. The user terminal of claim 1, wherein, based on the voice of the user being sensed while an execution screen of another application being executed in a foreground is displayed on the display unit, the controller performs a control operation to simultaneously display a screen of the selected object information and the execution screen of the other application by splitting a screen of the display unit.

12. The user terminal of claim 11, wherein, based on selection of the screen of the selected object information by the user, the controller performs a control operation to display the real-time image and the selected object information in full screen.

13. The user terminal of claim 1, further comprising a voice output unit,
wherein, based on a power saving mode of the display unit at a time point at which the voice of the user is sensed, the controller performs a control operation to output the selected object information only with audio through the voice output unit.

14. The user terminal of claim 13, wherein, based on the display unit switching to a non-power saving mode, the controller performs a control operation to display the real-time image and the selected object information in full screen.

15. The user terminal of claim 14, wherein the controller performs a control operation to output audio of different types according to a movement speed of the user.

16. The user terminal of claim 15, wherein the controller performs a control operation to
output audio of the selected object information of a simplified version based on the movement speed being equal to or greater than a certain speed, and
output audio of the selected object information of a detailed version based on the movement speed being less than the certain speed.

17. The user terminal of claim 1, wherein the controller performs a control operation to display the selected object information, based on the selected object being included within the real-time object and the selected object being located within a predetermined distance.

18. The user terminal of claim 1, wherein the controller performs a control operation to display a plurality of object information for the plurality of objects together with a plurality of object type icons.

19. The user terminal of claim 18, wherein, based on selection of at least one of the plurality of object type icons by the user, the controller performs a control operation to display only information of at least one object related to the selected at least one object type icon among the plurality of objects.

20. A method of controlling a user terminal, the method comprising:
displaying a real-time image sensed through a camera on a display unit;
analyzing, in real time, a plurality of objects included within the real-time image through analysis of the real-time image and selecting an object corresponding to voice of a user by analyzing, through artificial intelligence, at least one of a current location and a direction sensed through a location information module and the voice of the user input through a microphone; and
displaying the real-time image and selected object information of the selected object together while highlighting the selected object within the real-time image, based on the selected object being included within the real-time image currently displayed on the display unit.
